(19) United States
(12) Patent Application Publication
(10) Pub. No.: US 2020/0387907 A1
(43) Pub. Date: Dec. 10, 2020

(54) SYSTEM AND ELECTRONIC DEVICE FOR PERFORMING OFFLINE PAYMENT BY USING ONLINE AUTHENTICATION

(71) Applicant: Samsung Electronics Co., Ltd., Suwon-si, Gyeonggi-do (KR)

(72) Inventors: Taeyun KIM, Suwon-si (KR); Choongmin LEE, Suwon-si (KR); Kyeongmin KANG, Suwon-si (KR); Sinae LEE, Suwon-si (KR)

(21) Appl. No.: 16/971,519

(22) PCT Filed: Mar. 15, 2019
(86) PCT No.: PCT/KR2019/003004

§ 371 Date: Aug. 20, 2020

(30) Foreign Application Priority Data
Mar. 15, 2018 (KR) 10-2018-0030370

(51) Int. Cl. G06Q 20/40; G06Q 20/32; G06Q 20/20; G06Q 30/02

(52) U.S. Cl. CPC G06Q 20/40145; G06Q 20/3227; G06Q 30/0238; G06Q 20/20; G06Q 20/325

(57) ABSTRACT

A system according to one embodiment may: receive data for identification of a user account and payment-related information from a point-of-sale (POS) device; transmit a request for data for identification of the POS device and user authentication data to an electronic device corresponding to the user account; receive an authentication token or password data from the electronic device; transmit the received authentication token or password data to a first external server, and request the first external server for payment data; receive the payment data from the first external server; obtain approval for the payment from a second external server on the basis of the payment data and the payment-related information; and transmit data representing a result of the approval for the payment to the POS device through a communication interface.

### TECHNICAL FIELD

Embodiments disclosed in the disclosure relate to a technique of performing offline payment using online authentication.

### BACKGROUND ART

An electronic device is rapidly becoming highly functional due to the development of information technology (IT) to provide various functions to users. The electronic device may provide a multimedia service, for example, a music service, a video service, or a network-based communication service such as digital broadcasting service, call, wireless Internet, or the like.

Recently, a so-called fintech in which the finance technique and the above-mentioned IT technology are combined has attracted attention. FinTech, which is also considered to be the transition of financial paradigm, is expanding its appearance not only to conventional online financial services, but also to offline financial services and financial platform services.

For example, manufacturers of electronic devices are making various efforts for construction of the mobile payment platform, mobile payment services, and the proliferation of advanced mobile banking through collaboration with credit card companies or banks.

### DISCLOSURE

### Technical Problem

To implement a mobile payment service, an electronic device may be equipped with a magnetic stripe transmission or magnetic secure transmission (MST) module. The electronic device may complete a payment transaction with a conventional payment infrastructure (e.g., a point of sale (POS) terminal provided in a credit card merchant) by using the MST module.

However, an electronic device that does not include the MST module has a problem in that it cannot perform payment transactions through a conventional POS device. In addition, when the POS device does not include an NFC reader, there is a problem that payment transactions using the NFC method are impossible.

Various embodiments of the disclosure may enable offline payment using an electronic device that does not include an additional module for offline payment.

### Technical Solution

According to an embodiment disclosed in the disclosure, a system may include a communication interface, at least one memory that stores instructions, at least one processor operatively connected to the communication interface and the at least one memory, wherein the at least one processor may, by executing the stored instructions, receive data for identifying a user account and information related to payment from a point of sale (POS) device through the communication interface, transmit data for identifying the POS device and a request for user authentication data to an electronic device corresponding to the user account through the communication interface, receive an authentication token or password data from the electronic device through the communication interface, transmit the authentication token and the password data received to a first external server through the communication interface and request payment data, receive the payment data from the first external server through the communication interface, request an approval for the payment from a second external server through the communication interface based on the payment data and the information related to the payment, receive a result of the approval for the payment from the second external server through the communication interface, and transmit data indicating the result of the approval for the payment to the POS device through the communication interface.

Further, according to an embodiment disclosed in the disclosure, a method for providing offline payment through online authentication may include receiving data for identifying a user account and information related to payment from a point of sale (POS) device through a communication interface, transmitting data for identifying the POS device and a request for user authentication data to an electronic device corresponding to the user account through the communication interface, receiving an authentication token or password data from the electronic device through the communication interface, transmitting the authentication token and the password data received to a first external server through the communication interface and requesting payment data, receiving the payment data from the first external server through the communication interface, and transmitting the received payment data to the POS device through the communication interface.

Further, according to an embodiment disclosed in the disclosure, an electronic device may include a touch screen display, a wireless communication circuit, a biometric sensor, at least one memory that stores instructions, and at least one processor operatively connected to the touch screen display, the wireless communication circuit, the biometric sensor and the at least one memory, wherein the at least one processor may, by executing the stored instructions, transmit data for identifying a payment service account of a user to a point of sale (POS) device through the wireless communication circuit, receive data for identifying the POS device and a request for user authentication data from a first external server, obtain biometric information of the user through the biometric sensor or obtain a password through the touch screen display, perform user authentication in cooperation with the first external server through the wireless communication circuit using the obtained biometric information and the password, receive a result of the user authentication from the first external server through the wireless communication circuit, and display the result of the user authentication on the touch screen display.

### Advantageous Effects

According to the embodiments disclosed in the disclosure, it is possible to enable offline payment using a user terminal that does not include an additional payment module.

Further, according to the embodiments disclosed in the disclosure, offline payment through a user terminal may be possible even when a POS device does not include additional hardware for payment transactions.

In addition, various effects may be provided that are directly or indirectly understood through the disclosure.

### DESCRIPTION OF DRAWINGS

FIG. 1 illustrates a configuration of a payment system according to various embodiments of the disclosure.

FIG. 2 illustrates an environment in which payment transactions are made according to various embodiments.

FIG. 3 is a block diagram of an electronic device according to an embodiment.

FIG. 4 is a flowchart illustrating a process for issuing a payment token according to a biometric authentication method according to an embodiment.

FIG. 5 is a flowchart illustrating a process for issuing a payment token according to a password authentication method according to an embodiment.

FIG. 6 is a flowchart illustrating a method of performing offline payment in such a way that a payment service server requests payment approval from a VAN according to an embodiment.

FIG. 7 is a flowchart illustrating a method of performing offline payment in such a way that a POS device requests payment approval from a VAN according to an embodiment.

FIG. 8A illustrates a screen on which an electronic device according to an embodiment displays a payment method and information related to payment together.

FIG. 8B illustrates a screen for selecting a payment method according to an embodiment.

FIG. 8C illustrates a screen for selecting a payment plan according to an embodiment.

FIG. 8D illustrates a screen for inputting a use point according to an embodiment.

FIG. 9 is a block diagram of an electronic device 901 in a network environment 900 according to various embodiments.

In the description of the drawings, the same or similar reference numerals may be used for the same or similar components.

### MODE FOR INVENTION

Hereinafter, various embodiments of the disclosure may be described with reference to accompanying drawings. Accordingly, those of ordinary skill in the art will recognize that modification, equivalent, and/or alternative on the various embodiments described herein can be variously made without departing from the scope and spirit of the disclosure.

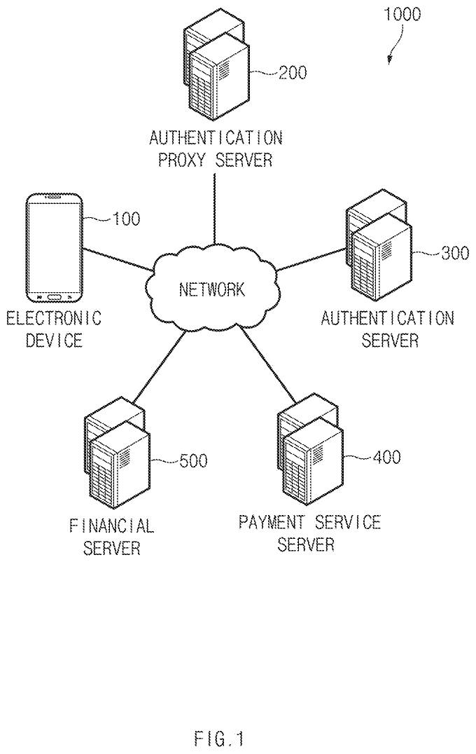

FIG. 1 illustrates a configuration of a payment system according to various embodiments of the disclosure.

Referring to FIG. 1, a payment system 1000 may include an electronic device 100, an authentication proxy server 200, an authentication server 300, a payment service server 400, a financial server 500, and a payment device (not shown). Components included in the payment system shown in FIG. 1 may be connected to each other through a network. For example, the electronic device 100, the authentication proxy server 200, the authentication server 300, the payment service server 400, and the financial server 500 may be connected to each other through a mobile communication network or an Internet network. For another example, the electronic device 100 and the payment device (not shown) may be connected to each other through a short-range wireless communication network (e.g., near field communication (NFC), wireless-fidelity (Wi-Fi), or magnetic secure transmission (MST)).

The payment system according to various embodiments of the disclosure may perform user authentication required in a process of registering or deleting payment information or performing payment through an external server, and identify whether a user is authenticated using a session key generated according to a result of user authentication.

The electronic device 100 may be a device used by a user who wants to proceed with payment (or withdrawal) according to various embodiments of the disclosure. The user may perform online/offline payment using the electronic device 100.

According to an embodiment, the electronic device 100 may provide a payment service using a payment application (e.g., Samsung Pay™ Application). According to an embodiment, the payment application may provide a user interface related to payment. For example, the payment application may provide a user interface related to card registration, payment, or transaction. In addition, the payment application may provide an interface related to user authentication through, for example, identification and verification (ID&V).

According to an embodiment, the electronic device 100 may store a payment service account (e.g., a Samsung account), a biometric authentication service account, and card information (or account information) associated with a user account.

According to an embodiment, the electronic device 100 may perform user authentication through a biometric authentication process. When a payment request is input from the user, the electronic device 100 may perform biometric authentication through the authentication proxy server 200 and the authentication server 300. According to an embodiment, when the biometric authentication is completed, the electronic device 100 may receive a biometric authentication session key from the authentication proxy server 200.

According to one embodiment, the electronic device 100 may request a payment token from the payment service server 400. According to an embodiment, the electronic device 100 may transmit the biometric authentication session key along with the payment token request to the payment service server 400. According to an embodiment, the electronic device 100 may perform payment (or withdrawal) using a payment token issued by the financial server 500.

The authentication proxy server 200 may request user authentication from the authentication server 300 at the request of the electronic device 100. According to an embodiment, the authentication proxy server 200 may manage a payment service account (e.g., a Samsung account), a biometric authentication service account, and card information (or account information) associated with a user account.

According to an embodiment, when an authentication result (or an authentication completion message) is received from the authentication server 300, the authentication proxy server 200 may generate a biometric authentication session key and store or transmit the biometric authentication session key to the electronic device 100. According to an embodiment, the biometric authentication session key may indicate that biometric authentication through the authentication server 300 is successful and may have a random value. According to one embodiment, the biometric authentication session key may have a specified validity period. For example, the authentication proxy server 200 may store the biometric authentication session key for the validity period and then delete the biometric authentication session key. According to an embodiment, the authentication proxy server 200 may change the validity period set in the biometric authentication session key. For example, the authentication proxy server 200 may change the validity period of the biometric authentication session key according to a policy of the payment system 1000.

According to an embodiment, when a biometric authentication verification request related to payment information is received from the financial server 500, the authentication proxy server 200 may verify biometric authentication using the biometric authentication session key. For example, the authentication proxy server 200 may receive the biometric authentication session key along with the biometric authentication verification request from the financial server 500. The authentication proxy server 200 may identify a biometric authentication result by comparing a stored biometric authentication session key and the biometric authentication session key received from the financial server 500. For example, when the biometric authentication session keys matches each other, the authentication proxy server 200 may determine that biometric authentication related to payment information is completed.

According to an embodiment, the authentication server 300 may perform user authentication at the request of the electronic device 100. According to an embodiment, the authentication server 300 may provide a fast identity online (FIDO) authentication service that performs user authentication using the user's biometric information. According to an embodiment, the authentication server 300 may perform user authentication using authentication information received from the electronic device 100. According to an embodiment, when the user authentication is completed, the authentication server 300 may transmit an authentication result to the authentication proxy server 200.

According to an embodiment, the payment service server 400 may transmit and receive information to and from the electronic device 100 and the financial server 500. According to an embodiment, the payment service server 400 may manage a payment service account (e.g., a Samsung account), a biometric authentication service account, and card information (or account information) associated with a user account.

According to an embodiment, the payment service server 400 may transmit a payment token request to the financial server 500 when a payment token is requested by the electronic device 100. According to an embodiment, the payment service server 400 may transmit the payment token request received from the electronic device 100 and the biometric authentication session key to the financial server 500. According to an embodiment, the payment service server 400 may transmit the payment token received from the financial server 500 to the electronic device 100.

According to an embodiment, the financial server 500 may be a server operated by a card company or a bank. According to an embodiment, the financial server 500 may issue a card and manage card information (or account information). According to an embodiment, the financial server 500 may finally determine whether to perform payment.

According to an embodiment, the financial server 500 may generate a payment token. According to an embodiment, when the payment token request is received from the payment service server 400, the financial server 500 may identify whether the user is authenticated from the authentication proxy server 200. For example, the financial server 500 may identify whether the user is authenticated by transmitting the biometric authentication session key received with the payment token request to the authentication proxy server 200. According to an embodiment, when a biometric authentication result is received from the authentication proxy server 200, the financial server 500 may generate a payment token and transmit the payment token to the electronic device 100 through the payment service server 400. According to various embodiments of the disclosure, the payment token may be generated by a token server separate from the financial server 500 and transmitted to the electronic device 100.

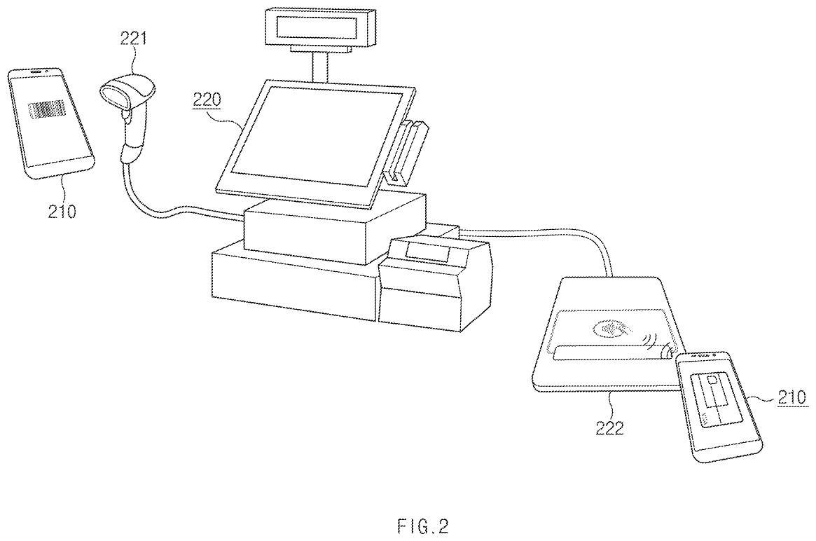

FIG. 2 illustrates an environment in which payment transactions are made according to various embodiments.

Referring to FIG. 2, an electronic device 210 (e.g., the electronic device 100) according to an embodiment may wirelessly interact with an external device 220. For example, the electronic device 210 may correspond to a smartphone equipped with a contactless payment module, and the external device 220 may correspond to a point of sale (POS) device.

According to an embodiment, the external device 220 may obtain data for identifying a user account by reading out a barcode using a barcode reader 221. For example, as illustrated in FIG. 2, the external device 220 may read out the barcode displayed on the electronic device 210.

Further, according to an embodiment, the electronic device 210 and the external device 220 may communicate with each other through an NFC channel. For example, when a user activates the NFC module embedded in or externally coupled to the electronic device 210, the electronic device 210 may generate and emit an electric field (or an electromagnetic field) of a specified frequency (e.g., 13.56 MHz) including data for identifying a user account using the activated NFC module. Then, when the electronic device 210 approaches an NFC reader 222 provided in the external device 220 within a specified distance (e.g., about 10 cm), the data for identifying the user account may be transmitted to the external device 220 through the emitted electric field (or an electromagnetic field).

According to various embodiments, the external device 220 may include a touch screen display. The external device 220 may receive the data for identifying the user account through a touch screen display.

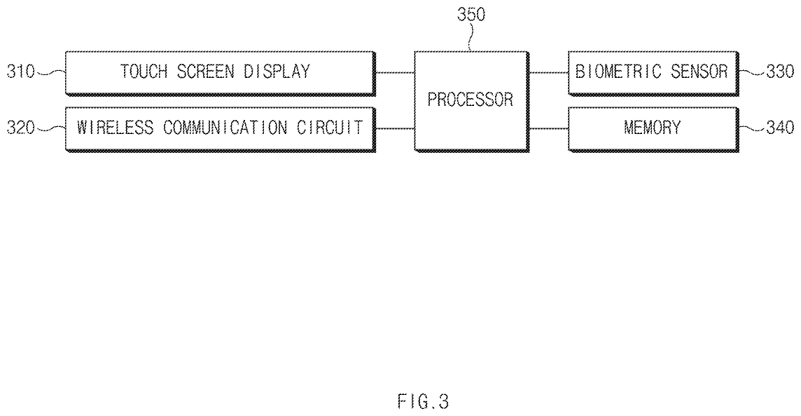

FIG. 3 is a block diagram of an electronic device according to an embodiment.

Referring to FIG. 3, an electronic device may include a touch screen display 310, a wireless communication circuit 320, a biometric sensor 330, a memory 340, a processor 350, and the like. According to an embodiment, the electronic device of FIG. 3 may correspond to the electronic device 100 of FIG. 1 and the electronic device 210 of FIG. 2.

The touch screen display 310 may output an execution screen of an application. In one embodiment, the display 310 may be implemented along with a touch panel (e.g., a touch screen display). According to an embodiment, the touch screen display 310 may be exposed through a housing.

The wireless communication circuit 320 may wirelessly communicate with an external server (e.g., the authentication proxy server 200, the authentication server 300, the payment service server 400, or the financial server 500) or an external device (e.g., a POS device).

According to an embodiment, the wireless communication circuit may provide Bluetooth communication, NFC communication, or cellular communication (e.g., LTE, LTE-A, CDMA, WCDMA, UMTS, WiBro, or GSM).

The biometric sensor 330 may detect or receive a biometric feature originated from a user's body. For example, the biometric sensor 330 may detect the biometric feature, convert the biometric feature into a digital value, and provide the converted digital value to the processor 350. The processor 350 may compare the converted digital value with an authentication value registered in the memory 340. The processor 350 may authenticate a legitimate user based on a comparison result. According to various embodiments, the comparison and user authentication may be performed using computing resources of a driver IC embedded in the biometric sensor 330. According to an embodiment, the biometric sensor 330 may include a sensor such as a fingerprint sensor, an iris sensor, and a vein sensor.

The memory 340 may be electrically connected to the processor 350 and may store instructions to be executed by the processor 350. According to one embodiment, the memory 340 may store applications to be executed by the processor 350, resources for providing a service through the external display 310, and the like. According to an embodiment, the memory 340 may store an authentication value related to a user's biometric information.

The processor 350 (e.g., the processor 120) may execute instructions stored in the memory 340 to perform operations to be described below.

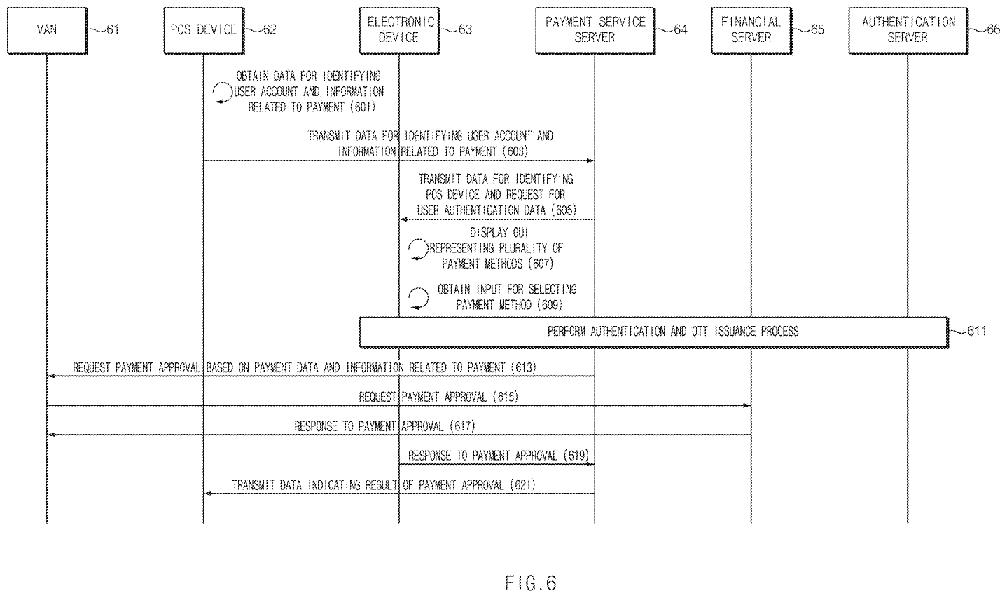

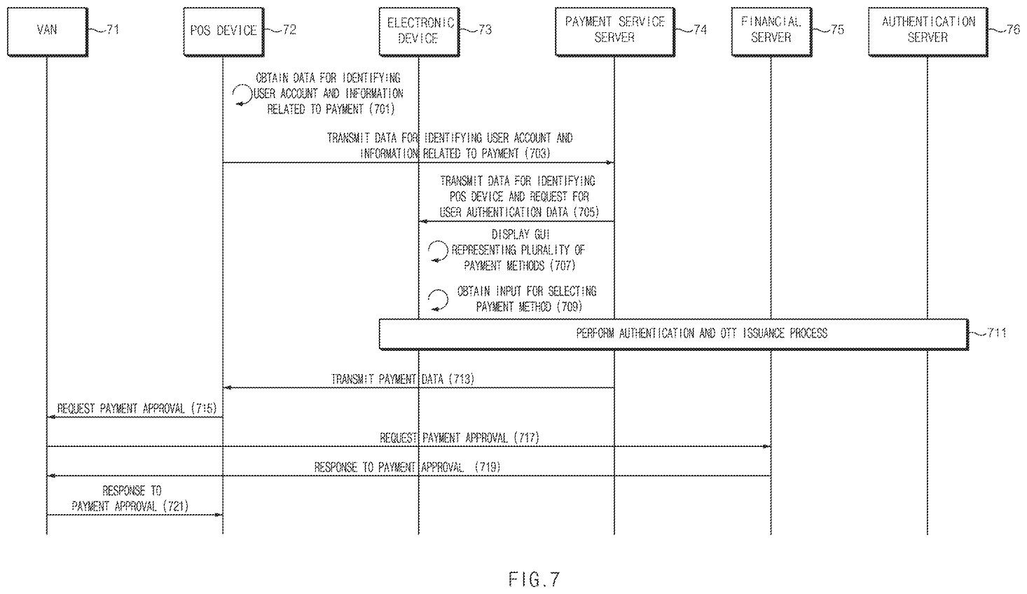

According to an embodiment, a method of issuing a payment token according to a fingerprint authentication method to be described later and a method of issuing a payment token according to a password authentication method may be used in a method of performing offline payment to be described with reference to FIGS. 6 and 7.

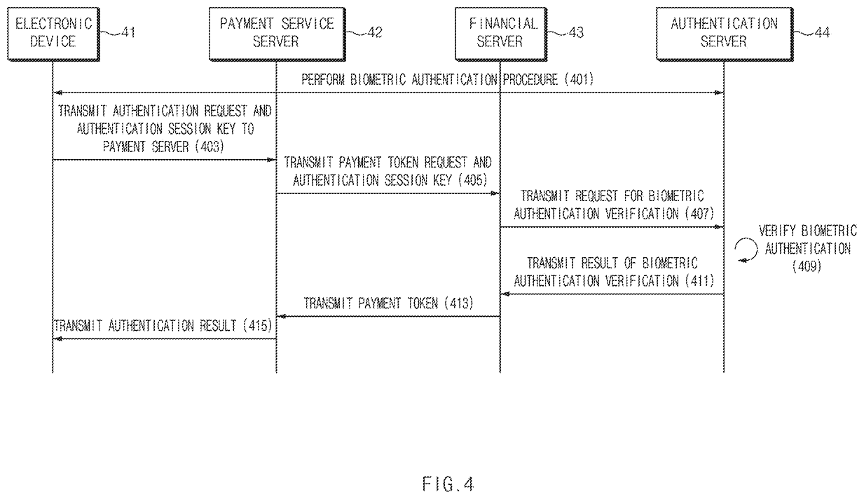

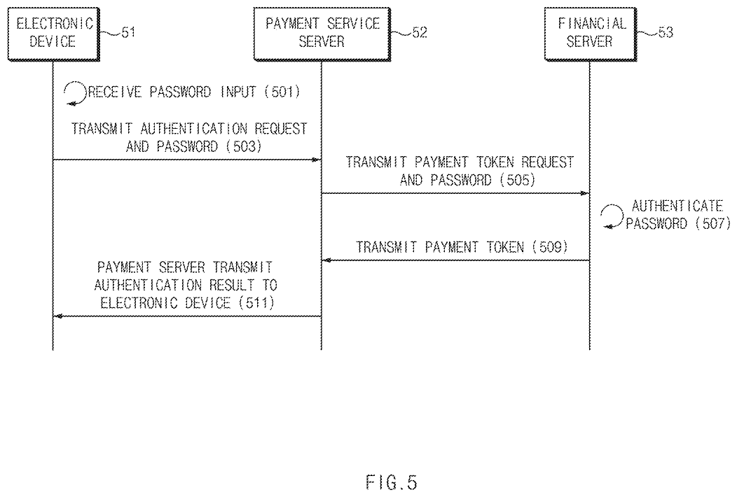

According to an embodiment, operations of FIGS. 4 and 5 may be performed by electronic devices 41 and 51, payment service servers 42 and 52, financial servers 43 and 53 and an authentication server 44. According to an embodiment, the electronic devices 41 and 51, the payment service servers 42 and 52, the financial servers 43 and 53, and the authentication server 44 in FIGS. 4 and 5 may respectively correspond to the electronic device 100, the payment service server 400, the financial server 500 and the authentication server 300 in FIG. 1.

According to one embodiment, operations performed by devices may be understood as being respectively performed by processors of the devices. According to an embodiment, the devices may communicate with each other through a wireless communication circuit or a communication interface.

FIG. 4 is a flowchart illustrating a process for issuing a payment token according to a biometric authentication method according to an embodiment.

In operation 401, the electronic device 41 and the authentication server 44 may perform a biometric authentication process.

According to an embodiment, the electronic device 41 may obtain biometric information of a user through the biometric sensor 330. According to an embodiment, the biometric information may include fingerprint information, iris information, vein pattern information or the like.

According to an embodiment, the electronic device 41 may detect a biometric feature through the biometric sensor 330, convert the biometric feature into a digital value, and compare the converted digital value and an authentication value registered in the memory 340. The electronic device 41 may authenticate the user based on a comparison result.

According to an embodiment, when user authentication is successful, the electronic device 41 may request an authentication session key from the authentication server 44. The authentication server 44 may generate the authentication session key and transmit the generated authentication session key to the electronic device 41.

In operation 403, the electronic device 41 may transmit an authentication request and the authentication session key to the payment service server 42.

According to an embodiment, the electronic device 41 may further transmit an identifier of a payment card and an identifier of a payment case to the payment service server 42.

In operation 405, the payment service server 42 may transmit a payment token request and a received authentication session key to the financial server 43.

According to an embodiment, the payment service server 42 may further transmit the identifier of the payment card and the identifier of the payment case received from the electronic device 41 to the financial server 43.

According to an embodiment, the payment token may be used by the payment service server 42 or a POS device to obtain a payment approval from a value added network (VAN).

When the electronic device performs payment, the VAN may transmit the user's information to the financial server and provide a service authenticated by the financial server.

In operation 407, the financial server 43 may transmit a verification request for biometric authentication to the authentication server 44.

According to an embodiment, the financial server 43 may transmit the received authentication session key to the authentication server 44 to verify biometric authentication.

In operation 409, the authentication server 44 may verify biometric authentication.

According to one embodiment, the authentication server 44 may verify biometric authentication by comparing the authentication session key provided to the electronic device 41 in operation 401 with the authentication session key received from the financial server 43.

In operation 411, the authentication server 44 may transmit a result of the verification of the biometric authentication to the financial server 43.

In operation 413, if the biometric authentication is successful, the financial server 43 may generate a payment token and transmit the generated payment token to the payment service server 42.

According to an embodiment, the financial server 43 may generate a payment token corresponding to the identifier of the payment card and the identifier of the payment case received.

In operation 415, the payment service server 42 may transmit a result of biometric authentication to the electronic device 41.

According to an embodiment, when the biometric authentication is successful, the payment service server 42 may transmit a response indicating that the biometric authentication is successful to the electronic device 41.

According to an embodiment, the electronic device 41 may display the result of biometric authentication.

FIG. 5 is a flowchart illustrating a process for issuing a payment token according to a password authentication method according to an embodiment.

In operation 501, the electronic device 51 may receive a password input through the touch screen display 310.

According to an embodiment, a password may include at least one of numbers, letters, or special characters. According to various embodiments, the password may include a touch pattern or the like.

In operation 503, the electronic device 51 may transmit an authentication request and password data to the payment service server 52.

According to an embodiment, the electronic device 51 may further transmit an identifier of a payment card and an identifier of a payment case to the payment service server 52.

According to an embodiment, the password data may be data in which the input password is encrypted.

In operation 505, the payment service server 52 may transmit a payment token request and the received password data to the financial server 53.

According to an embodiment, the payment service server 52 may further transmit the identifier of the payment card and the identifier of the payment case received from the electronic device 51 to the financial server 53.

According to an embodiment, the payment token may be used by a payment service server or a POS device to obtain a payment approval from a VAN in a process to be described later.

In operation 507, the financial server 53 may authenticate the received password (e.g., verify password data).

According to an embodiment, the financial server 53 may verify the received password data by comparing the received password data with the password data corresponding to an identifier of a payment card which is stored in advance.

In operation 509, the financial server 53 may generate a payment token when a password verification is successful, and transmit the generated payment token to the payment service server 52.

According to an embodiment, the financial server 53 may generate a payment token corresponding to the identifier of the payment card and the identifier of the payment case received.

In operation 511, the payment service server 52 may transmit a result of the password verification to the electronic device 51.

According to an embodiment, when the password verification is successful, the payment service server 42 may transmit a response indicating that the password verification is successful to the electronic device 41.

According to an embodiment, the electronic device 51 may display a result of the password verification.

Hereinafter, a process by which offline payment of the disclosure is performed will be described with reference to FIGS. 6 and 7.

According to an embodiment, operations of FIGS. 6 and 7 may be performed by POS devices 62 and 72, electronic devices 63 and 73, VANs 63 and 71, payment service servers 64 and 75, financial servers 65 and 75 and authentication servers 66 and 76. According to an embodiment, the electronic devices 63 and 73, the payment service servers 64 and 75, the financial servers 65 and 75, and the authentication servers 66 and 76 in FIGS. 6 and 7 may respectively correspond to the electronic devices 41 and 51, the payment service servers 42 and 52, the financial servers 43 and 53 and the authentication server 44 in FIGS. 4 and 5. According to an embodiment, the POS devices 62 and 72 of FIGS. 6 and 7 may correspond to the external device 220 of FIG. 2.

According to one embodiment, operations performed by devices may be understood as being respectively performed by processors of the devices. According to an embodiment, the devices may communicate with each other through a wireless communication circuit or a communication interface.

FIG. 6 is a flowchart illustrating a method of performing offline payment in such a way that a payment service server requests payment approval from a VAN according to an embodiment.

In operation 601, the POS device 62 may obtain data for identifying a user account and information related to payment.

According to an embodiment, the POS device 62 may obtain data for identifying a user account through input by the user. For example, the data for identifying a user account may include a user's phone number, the user account, or the like.

According to an embodiment, the POS device 62 may obtain data for identifying the user account wirelessly from the user's electronic device 63. For example, the POS device 62 may include an NFC reader, and the POS device 62 may receive data for identifying a user account from the user's electronic device 63 through NFC communication.

As another example, the POS device 62 may include a barcode reader, and the POS device 62 may obtain data for identifying a user account by reading out a barcode using a barcode reader.

According to an embodiment, information related to payment may include at least one of a payment amount or installment information.

In operation 603, the POS device 62 may transmit data for identifying a user account and information related to payment to the payment service server 64.

According to an embodiment, the POS device 62 may transmit the data for identifying the user account and the information related to payment to the payment service server 64, and then periodically poll a status value indicating a payment approval result stored in the payment service server 64 to be described later.

According to an embodiment, the payment service server 64 may store the received data for identifying the user account and the information related to payment, and generate an identifier of a payment case corresponding to the received data for identifying the user account and the information related to payment.

In operation 605, the payment service server 64 may transmit the data for identifying the POS device 62 and a request for user authentication data to the electronic device 63.

According to an embodiment, the payment service server 64 may further transmit information related to payment (e.g., payment amount) to the electronic device 63.

According to an embodiment, the payment service server 64 may transmit the data for identifying the POS device 62 and a request for user authentication data to the electronic device 63 in the form of a push message.

According to an embodiment, the payment service server 64 may further transmit an identifier of the generated payment case.

In operation 607, the electronic device 63 may display a graphic user interface (GUI) representing a plurality of payment methods.

According to an embodiment, the electronic device 63 may display a request according to operation 605 on the touch screen display before displaying the GUI representing a plurality of payment methods. According to an embodiment, when a user input for approving the displayed request is received, the electronic device 63 may display a GUI representing a plurality of payment methods.

According to an embodiment, the electronic device 63 may request additional information related to payment corresponding to the POS device 62 from the payment service server 64. The payment service server 64 may request additional information related to payment corresponding to the POS device 62 of the electronic device 63 from the financial server 65 in response to the request. The financial server 65 may transmit the additional information related to payment to the payment service server 64 in response to the request, and the payment service server 64 may transmit the received additional information related to the payment to the electronic device 63.

According to an embodiment, the additional information related to payment may include information on benefits that may be received when payment is made through the POS device 62 using a payment method. For example, the information on the benefits may include at least one of coupon information, point accumulation information, or amount discount information. According to an embodiment, benefits that may be received when payment is made with a first card at one payment place and benefits that may be received when payment is made with a second card may be different.

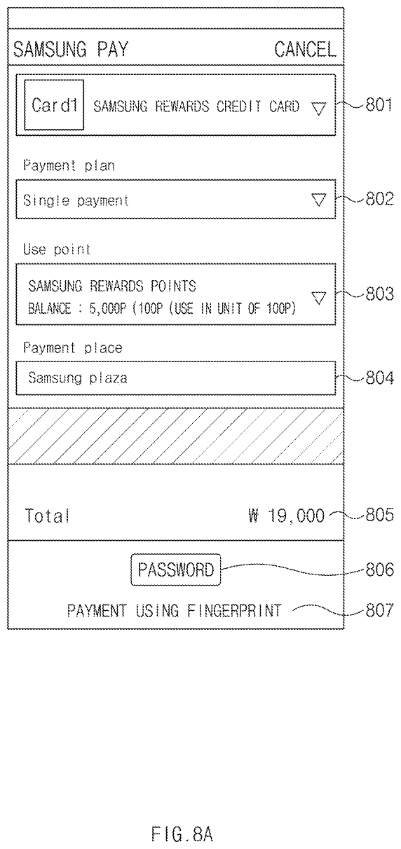

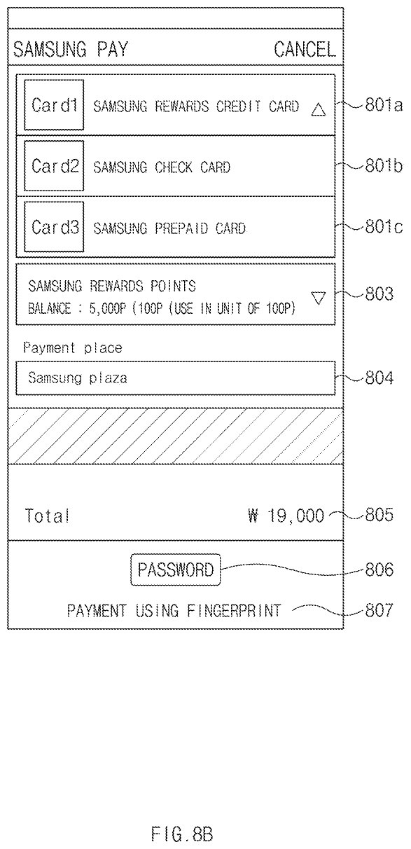

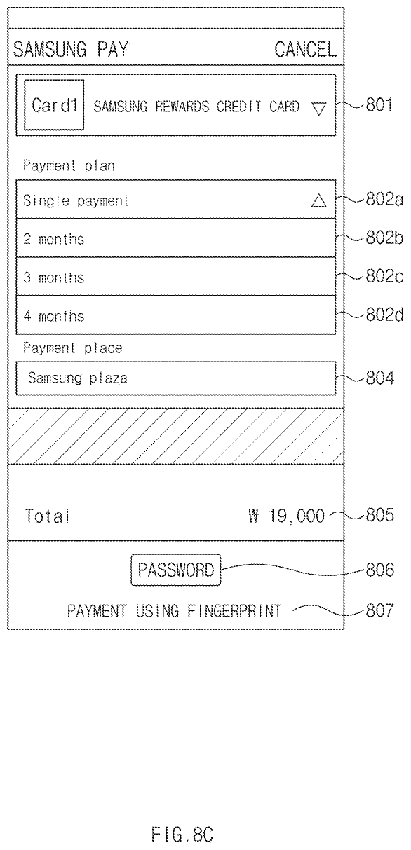

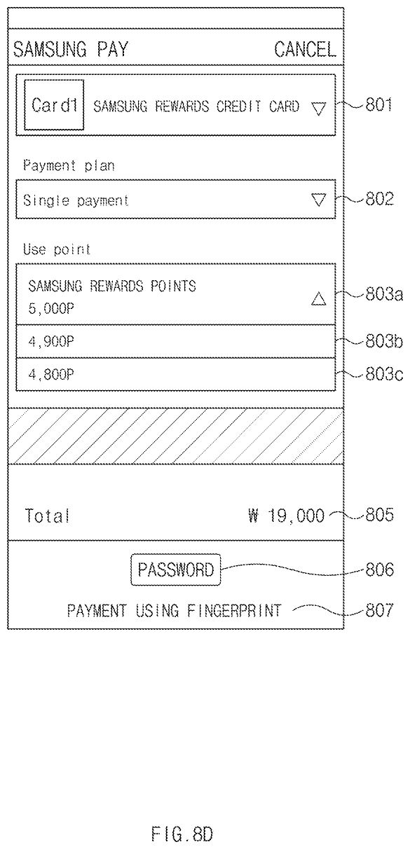

According to an embodiment, when the electronic device 63 receives information related to payment, the electronic device 63 may display a plurality of payment methods and information related to payment together. An example in which the electronic device 63 displays the payment method and the information related to payment together will be described with reference to FIGS. 8A to 8D below.

In operation 609, the electronic device 63 may obtain an input for selecting one of the plurality of payment methods.

According to an embodiment, the electronic device 63 may obtain an input for selecting one payment method through the touch screen display 310. According to an embodiment, the electronic device 63 may obtain a user speech input through a microphone and select one payment method based on the user speech input.

In operation 611, the electronic device 63, the payment service server 64, the financial server 65, and the authentication server 66 may perform a user authentication and a one time token (OTT) issuance process.

According to an embodiment, the OTT may be a payment token that may be used once. According to an embodiment, operation 621 may be a process for issuing a payment token according to the biometric authentication method described above with reference to FIG. 4 or a process for issuing a payment token according to the password authentication method described above with reference to FIG. 5.

In operation 613, the payment service server 64 may request a payment approval from the VAN 63 based on payment data and information related to payment.

According to an embodiment, the payment data may include the OTT issued in operation 611. According to an embodiment, the payment service server 64 may transmit the OTT to the VAN 63 and may request a payment approval from the VAN 63 according to a payment amount and installment information included in the information related to payment.

In operation 615, the VAN 63 may request a payment approval from the financial server 65.

According to an embodiment, the VAN 63 may transmit the received OTT to the financial server 65 and may request a payment approval from the financial server 65 according to the payment amount and the installment information which are requested.

In operation 617, the financial server 65 may transmit a response to the request for the payment approval to the VAN 63.

According to an embodiment, the financial server 65 may compare the received OTT with the OTT issued in operation 621, determine presence or absence of the payment approval according to a comparison result, and transmit the presence or absence of the payment approval to VAN 63.

In operation 619, the VAN 63 may transmit a response to the request for the payment approval to the payment service server 64.

According to an embodiment, the VAN 63 may transmit a response to the request for the payment approval of the payment service server 64 according to the response received from the financial server 65.

In operation 621, the payment service server 64 may transmit data indicating a result of payment approval to the POS device 62.

According to various embodiments, the payment service server 64 may change a status value indicating the result of the payment approval according to the response from the VAN 63. As described above in the description of operation 603, the POS device 62 may poll a status value indicating the result of the payment approval. The POS device 62 may detect a change in the status value, and detect that payment is approved according to the detected change in the status value. According to various embodiments, the payment service server 64 may transmit the data indicating the result of the payment approval to the POS device 62 in response to the polling of the POS device 62.

According to an embodiment, the POS device 62 may display the result of the payment approval.

FIG. 7 is a flowchart illustrating a method of performing offline payment in such a way that a POS device requests payment approval from a VAN according to an embodiment.

In operation 701, the POS device 72 may obtain data for identifying a user account and information related to payment.

In operation 703, the POS device 72 may transmit data for identifying a user account and information related to payment to the payment service server 74.

According to an embodiment, the POS device 72 may transmit the data for identifying the user account and the information related to payment to the payment service server 74, and then periodically poll a status value indicating a user authentication result stored in the payment service server 74 to be described later.

In operation 705, the payment service server 74 may transmit the data for identifying the POS device 72 and a request for user authentication data to the electronic device 73.

In operation 707, the electronic device 73 may display a GUI representing a plurality of payment methods.

In operation 709, the electronic device 73 may obtain an input for selecting one of the plurality of payment methods.

In operation 711, the electronic device 73, the payment service server 74, the financial server 75, and the authentication server 76 may perform user authentication and an OTT issuance process.

According to various embodiments, the payment service server 74 may change the status value indicating a result of the user authentication according to a result of the user authentication. As described above in the description of operation 703, the POS device 72 may poll the status value indicating the result of the user authentication. The POS device 72 may detect the change in the status value, and detect whether or not authentication is successful according to the detected change in the status value.

According to an embodiment, operations 701 to 711 may correspond to operations 601 to 611 described above. According to an embodiment, embodiments that may be applied to the operations 601 to 611 may also be applied to operations 701 to 711.

In operation 713, the payment service server 74 may transmit payment data to the POS device 72.

According to an embodiment, the payment data may include the OTT issued in operation 721.

According to various embodiments, the payment service server 74 may change the status value indicating the result of the user authentication according to the response from the VAN 71. As described above in the description of operation 603, the POS device 72 may poll the status value indicating the result of the user authentication. The POS device 72 may detect a change in the status value, and detect whether the user authentication is successful according to the detected change in the status value.

According to various embodiments, the payment service server 74 may transmit the issued OTT to the POS device 72 in response to the polling of the POS device 72.

In operation 715, the POS device 72 may request payment approval from the VAN 71 based on payment data and information related to payment.

According to an embodiment, the payment data may include the OTT received from the payment service server 74. According to an embodiment, the payment service server 74 may transmit the OTT to the VAN 71 and may request a payment approval from the VAN 71 according to a payment amount and installment information included in the information related to payment.

In operation 717, the VAN 71 may request payment approval from the financial server 75.

According to an embodiment, the VAN 71 may transmit the received OTT to the financial server 75 and may request a payment approval from the financial server 75 according to the payment amount and the installment information which are requested.

In operation 719, the financial server 75 may transmit a response to the request for the payment approval to the VAN 71.

According to an embodiment, the financial server 75 may compare the received OTT with the OTT issued in operation 621, determine presence or absence of the payment approval according to a comparison result, and transmit the presence or absence of the payment approval to VAN 71.

In operation 721, the VAN 71 may transmit a response to the payment approval request to the POS device 72.

According to an embodiment, the VAN 71 may transmit a response to the request for the payment approval of the POS device 72 according to the response received from the financial server 75.

According to an embodiment, the response to the request for the payment approval may include a result of payment approval. In one embodiment, the POS device 72 may display the result of payment approval.

FIG. 8A illustrates a screen on which an electronic device according to an embodiment displays a payment method and information related to payment together. FIG. 8B illustrates a screen for selecting a payment method according to an embodiment. FIG. 8C illustrates a screen for selecting a payment plan according to an embodiment. FIG. 8D illustrates a screen for inputting a use point according to an embodiment.

Referring to FIG. 8A, the electronic device may display a UI object 801 representing a payment method on a touch screen display, an object 802 representing installment information, a UI object 803 representing a use point (e.g., rewards points of a payment method), an object 804 representing a payment place, an object 805 representing a payment amount, a UI object 806 for selecting a password authentication method, and an object 807 representing a biometric authentication method.

According to an embodiment, when the electronic device receives an input for selecting the object 801 representing the payment method, the electronic device may display a plurality of payment methods available. The plurality of payment methods may include, for example, credit cards, check cards, prepaid cards, and the like. As another example, the plurality of payment methods may include various types of credit cards.

For example, when the electronic device receives an input for selecting the object 801 representing a payment method, as shown in FIG. 8B, the electronic device may display a Samsung rewards credit card 801a, a Samsung check card 801b, and a Samsung prepaid card 801c. In one embodiment, the electronic device may receive an input for selecting one of a plurality of displayed payment methods 801a, 801b and 801c. The electronic device may perform payment using the selected payment method.

According to an embodiment, when the electronic device receives an input for selecting the object 802 representing installment information, the electronic device may display an available payment plan. The payment plan may include, for example, a single payment, a two-month installment, and a three-month installment.

For example, when the electronic device receives an input for selecting the object 802 indicating installment information, as shown in FIG. 8C, the electronic device may display a single payment 802a, a two-month installment 802b, a three-month installment 802c and a four-month installment 802d. In one embodiment, the electronic device may receive an input for selecting the displayed installment period. The electronic device may perform payment according to the selected installment period.

According to an embodiment, when the electronic device receives an input for selecting the object 803 representing a use point, the electronic device may display an input window for inputting a point to be used by the user.

For example, when the electronic device receives the input for selecting the object 803 representing a use point, as shown in FIG. 8D, the electronic device may display available use points (e.g., 5000 points (803a) and 4900 points (803b), or 4800 points (803c)). In an embodiment, the electronic device may receive an input for selecting points to be used. The electronic device may use the selected points when performing payment.

According to an embodiment, the electronic device may display the payment place 804 corresponding to a POS device performing payment on the payment place item.

According to an embodiment, the electronic device may display the payment amount 805 included in the information related to payment obtained in operation 701 or operation 801.

According to an embodiment, when the electronic device receives an input for selecting the object 806 for selecting a password authentication method, the electronic device may display an input window through which the user is able to input a password. According to an embodiment, the electronic device may perform a process of performing user authentication using the password authentication method described above using the input password.

According to an embodiment, the electronic device may display a message 807 indicating that user authentication is able to be performed using a fingerprint authentication method. According to an embodiment, the electronic device may obtain the user's fingerprint information through a fingerprint sensor, and perform the above-described biometric authentication process using the obtained fingerprint information.

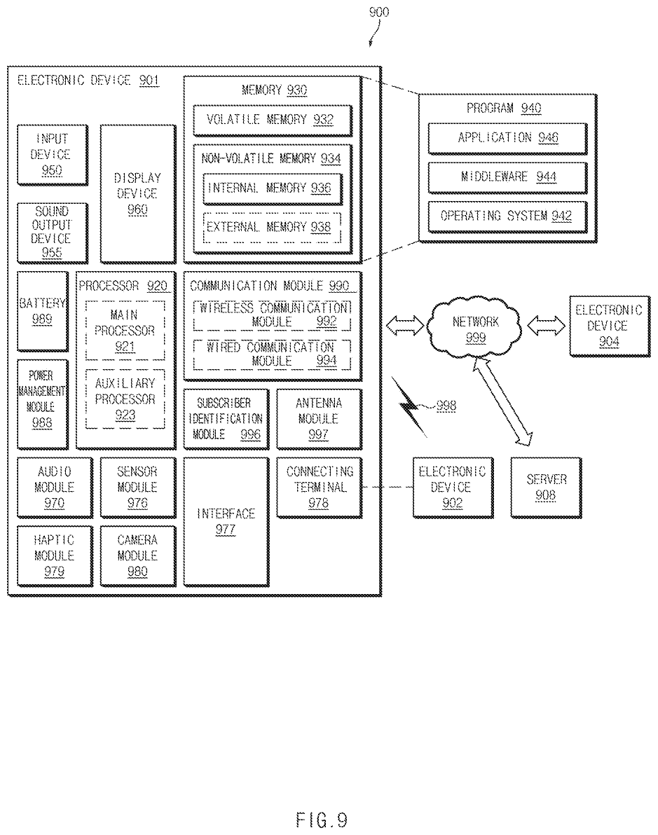

FIG. 9 is a block diagram illustrating an electronic device 901 in a network environment 900 according to various embodiments. Referring to FIG. 9, the electronic device 901 in the network environment 900 may communicate with an electronic device 902 via a first network 998 (e.g., a short-range wireless communication network), or an electronic device 904 or a server 908 via a second network 999 (e.g., a long-range wireless communication network). According to an embodiment, the electronic device 901 may communicate with the electronic device 904 via the server 908. According to an embodiment, the electronic device 901 may include a processor 920, memory 930, an input device 950, a sound output device 955, a display device 960, an audio module 970, a sensor module 976, an interface 977, a haptic module 979, a camera module 980, a power management module 988, a battery 989, a communication module 990, a subscriber identification module (SIM) 996, or an antenna module 997. In some embodiments, at least one (e.g., the display device 960 or the camera module 980) of the components may be omitted from the electronic device 901, or one or more other components may be added in the electronic device 901. In some embodiments, some of the components may be implemented as single integrated circuitry. For example, the sensor module 976 (e.g., a fingerprint sensor, an iris sensor, or an illuminance sensor) may be implemented as embedded in the display device 960 (e.g., a display).

The processor 920 (e.g., the processor 350) may execute, for example, software (e.g., a program 940) to control at least one other component (e.g., a hardware or software component) of the electronic device 901 coupled with the processor 920, and may perform various data processing or computation. According to one embodiment, as at least part of the data processing or computation, the processor 920 may load a command or data received from another component (e.g., the sensor module 976 or the communication module 990) in volatile memory 932, process the command or the data stored in the volatile memory 932, and store resulting data in non-volatile memory 934. According to an embodiment, the processor 920 may include a main processor 921 (e.g., a central processing unit (CPU) or an application processor (AP)), and an auxiliary processor 923 (e.g., a graphics processing unit (GPU), an image signal processor (ISP), a sensor hub processor, or a communication processor (CP)) that is operable independently from, or in conjunction with, the main processor 921. Additionally or alternatively, the auxiliary processor 923 may be adapted to consume less power than the main processor 921, or to be specific to a specified function. The auxiliary processor 923 may be implemented as separate from, or as part of the main processor 921.

The auxiliary processor 923 may control at least some of functions or states related to at least one component (e.g., the display device 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). According to an embodiment, the auxiliary processor 923 (e.g., an image signal processor or a communication processor) may be implemented as part of another component (e.g., the camera module 980 or the communication module 990) functionally related to the auxiliary processor 923.

The memory 930(e.g., the memory 340) may store various data used by at least one component (e.g., the processor 920 or the sensor module 976) of the electronic device 901. The various data may include, for example, software (e.g., the program 940) and input data or output data for a command related thererto. The memory 930 may include the volatile memory 932 or the non-volatile memory 934.

The program 940 may be stored in the memory 930 as software, and may include, for example, an operating system (OS) 942, middleware 944, or an application 946.

The input device 950 may receive a command or data to be used by other component (e.g., the processor 920) of the electronic device 901, from the outside (e.g., a user) of the electronic device 901. The input device 950 may include, for example, a microphone, a mouse, or a keyboard.

The sound output device 955 may output sound signals to the outside of the electronic device 901. The sound output device 955 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 960 (e.g., touch screen display 310) may visually provide information to the outside (e.g., a user) of the electronic device 901. The display device 960 may include, for example, a display, a hologram device, or a projector and control circuitry to control a corresponding one of the display, hologram device, and projector. According to an embodiment, the display device 960 may include touch circuitry adapted to detect a touch, or sensor circuitry (e.g., a pressure sensor) adapted to measure the intensity of force incurred by the touch.

The audio module 970 may convert a sound into an electrical signal and vice versa. According to an embodiment, the audio module 970 may obtain the sound via the input device 950, or output the sound via the sound output device 955 or a headphone of an external electronic device (e.g., an electronic device 902) directly (e.g., wiredly) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. According to an embodiment, the sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor (e.g., biometric sensor 330), a temperature sensor, a humidity sensor, or an illuminance sensor.

The interface 977 may support one or more specified protocols to be used for the electronic device 901 to be coupled with the external electronic device (e.g., the electronic device 902) directly (e.g., wiredly) or wirelessly. According to an embodiment, the interface 977 may include, for example, a high definition multimedia interface (HDMI), a universal serial bus (USB) interface, a secure digital (SD) card interface, or an audio interface.

A connecting terminal 978 may include a connector via which the electronic device 901 may be physically connected with the external electronic device (e.g., the electronic device 902). According to an embodiment, the connecting terminal 978 may include, for example, a HDMI connector, a USB connector, a SD card connector, or an audio connector (e.g., a headphone connector),

The haptic module 979 may convert an electrical signal into a mechanical stimulus (e.g., a vibration or a movement) or electrical stimulus which may be recognized by a user via his tactile sensation or kinesthetic sensation. According to an embodiment, the haptic module 979 may include, for example, a motor, a piezoelectric element, or an electric stimulator.

The camera module 980 may capture a still image or moving images. According to an embodiment, the camera module 980 may include one or more lenses, image sensors, image signal processors, or flashes.

The power management module 988 may manage power supplied to the electronic device 901. According to one embodiment, the power management module 988 may be implemented as at least part of, for example, a power management integrated circuit (PMIC).

The battery 989 may supply power to at least one component of the electronic device 901. According to an embodiment, the battery 989 may include, for example, a primary cell which is not rechargeable, a secondary cell which is rechargeable, or a fuel cell.

The communication module 990(e.g., the wireless communication circuit 320) may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the application processor (AP)) and supports a direct (e.g., wired) communication or a wireless communication. According to an embodiment, the communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as Bluetooth™, wireless-fidelity (Wi-Fi) direct, or infrared data association (IrDA)) or the second network 999 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The antenna module 997 may transmit or receive a signal or power to or from the outside (e.g., the external electronic device) of the electronic device 901. According to an embodiment, the antenna module 997 may include one or more antennas, and, therefrom, at least one antenna appropriate for a communication scheme used in the communication network, such as the first network 998 or the second network 999, may be selected, for example, by the communication module 990 (e.g., the wireless communication module 992). The signal or the power may then be transmitted or received between the communication module 990 and the external electronic device via the selected at least one antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 901 and the external electronic device 904 via the server 908 coupled with the second network 999. Each of the electronic devices 902 and 904 may be a device of a same type as, or a different type, from the electronic device 901. According to an embodiment, all or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 901. The electronic device 901 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 940) including one or more instructions that are stored in a storage medium (e.g., internal memory 936 or external memory 938) that is readable by a machine (e.g., the electronic device 901). For example, a processor (e.g., the processor 920) of the machine (e.g., the electronic device 901) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. A system comprising:
a communication interface;
at least one memory configured to store instructions; and
at least one processor operatively connected to the communication interface and the at least one memory, wherein the at least one processor is configured to, by executing the stored instructions,
receive data for identifying a user account and information related to payment from a point of sale (POS) device through the communication interface,
transmit data for identifying the POS device and a request for user authentication data to an electronic device corresponding to the user account through the communication interface,
receive an authentication token or password data from the electronic device through the communication interface,
transmit the authentication token and the password data received to a first external server through the communication interface and request payment data,
receive the payment data from the first external server through the communication interface,
request an approval for the payment from a second external server through the communication interface based on the payment data and the information related to the payment,
receive a result of the approval for the payment from the second external server through the communication interface, and
transmit data representing the result of the approval for the payment to the POS device through the communication interface.

2. The system of claim 1, wherein the data for identifying the user account includes at least one of a phone number of a user or an account of the user.

3. The system of claim 1, wherein the information related to payment includes at least one of a payment amount or installment information.

4. The system of claim 1, wherein the at least one processor further transmits the information related to payment to the electronic device corresponding to the user account through the communication interface.

5. The system of claim 1, wherein the at least one processor is configured to
generate a payment identifier corresponding to the information related to the payment, and
further transmit the generated payment identifier to the electronic device through the communication interface.

6. The system of claim 1, wherein the at least one processor is configured to
request additional information related to the payment corresponding to the POS device from the first external server through the communication interface,
receive the additional information related to the payment from the first external server through the communication interface, and
transmit the received additional information related to the payment to the electronic device through the communication interface.

7. The system of claim 6, wherein the additional information related to the payment includes at least one of coupon information, point accumulation information, or amount discount information.

8. The system of claim 1, wherein the payment data includes a single-use payment token.

9. A method for providing offline payment through online authentication, the method comprising:
receiving data for identifying a user account and information related to payment from a point of sale (POS) device through a communication interface;
transmitting data for identifying the POS device and a request for user authentication data to an electronic device corresponding to the user account through the communication interface;
receiving an authentication token or password data from the electronic device through the communication interface;
transmitting the authentication token and the password data received to a first external server through the communication interface and requesting payment data;
receiving the payment data from the first external server through the communication interface; and
transmitting the received payment data to the POS device through the communication interface.

10. The method of claim 9, further comprising:
generating a payment identifier corresponding to the information related to the payment when the information related to the payment is received, and
wherein the transmitting of the data for identifying the POS device and the request for the user authentication data to the electronic device corresponding to the user account includes transmitting the generated payment identifier to the electronic device.

11. The method of claim 9, further comprising:
before transmitting the data for identifying the POS device and the request for the user authentication data to an electronic device,
requesting additional information related to the payment corresponding to the POS device from the first external server through the communication interface, and
receiving the additional information related to the payment from the first external server through the communication interface,
wherein the transmitting of the data for identifying the POS device and the request for user authentication data to the electronic device includes transmitting the received additional information related to payment to the electronic device through the communication interface.

12. The method of claim 9, wherein the payment data includes a single-use payment token.

13. An electronic device comprising:
a touch screen display;
a wireless communication circuit;
a biometric sensor;
at least one memory configured to store instructions; and
at least one processor operatively connected to the touch screen display, the wireless communication circuit, the biometric sensor and the at least one memory, wherein the at least one processor is configured to, by executing the stored instructions,
transmit data for identifying a payment service account of a user to a point of sale (POS) device through the wireless communication circuit,
receive data for identifying the POS device and a request for user authentication data from a first external server,
obtain biometric information of the user through the biometric sensor or obtain a password through the touch screen display,
perform user authentication in cooperation with the first external server through the wireless communication circuit using the obtained biometric information and the password,
receive a result of the user authentication from the first external server through the wireless communication circuit, and
display the result of the user authentication on the touch screen display.

14. The electronic device of claim 13, wherein the memory further stores data related to a plurality of payment methods,
wherein the at least one processor is configured to, by executing the stored instructions,
display a graphic user interface representing the plurality of payment methods on the touch screen display before obtaining the biometric information and the password,
receive a user input for selecting one of the plurality of payment methods through the touch screen display, and
perform user authentication in cooperation with the first external server through the wireless communication circuit further using data related to the selected payment method.

15. The electronic device of claim 13, wherein the memory stores data related to a plurality of payment methods,
wherein the at least one processor is configured to, by executing the stored instructions,
request additional information related to payment through the POS device from the first external server through the wireless communication circuit before obtaining the biometric information and the password,
receive the additional information related to the payment through the POS device from the first external server through the wireless communication circuit, and
display the received additional information related to the payment through the POS device on the touch screen display.
